(19) United States
(12) Patent Application Publication
(10) Pub. No.: US 2024/0065907 A1
(43) Pub. Date: Feb. 29, 2024

(54) Patient Support Apparatus With Removable Part Comprising Self Locking Cradle Mechanism

(71) Applicant: Linet Spol. S R.O, Slany (CZ)

(72) Inventor: Martin Ertelt, Fulnek (CZ)

(73) Assignee: Linet Spol. S R.O, Slany (CZ)

(21) Appl. No.: 18/259,742

(22) PCT Filed: Dec. 27, 2021
(86) PCT No.: PCT/CZ2021/000060

§ 371 Date: Jun. 28, 2023

(30) Foreign Application Priority Data
Dec. 29, 2020 (CZ) PV2020-723

(51) Int. Cl. A61G 7/05

(52) U.S. Cl. CPC A61G 7/0509; A61G 7/0506; A61G 7/0513

(57) ABSTRACT

A self-locking cradle mechanism for locking removable parts of a patient support apparatus. Parts are removable from the patient support apparatus so that a caregiver could have better access to a patient. The removable parts also create a standard accessory of patient support apparatus, which may be in the form of a medical bed, a nursery bed and the like. The patient support apparatus may comprise removable parts, such as headboards, footboards, poles, accessory stands, protectors, etc. A self-locking cradle mechanism comprises a control element and a rod located at one part of the patient support apparatus frame, and a cradle latch located on another part of the frame. The cradle latch moves spontaneously swinging to the unlocked and locked position between a shaped stop on the frame and the rod, which both restrict space for free movement of the cradle latch.

### TECHNICAL FIELD

A technical solution describes a self-locking cradle mechanism for locking of removable parts of patient support apparatuses. Such parts are removable from patient support apparatuses so that a caregiver could have better access to a patient and such removable parts create, at present, standard accessory of each patient support apparatus such as medical bed, nursery bed etc. Patient support apparatuses may comprise removable parts such as headboards, footboards, poles, accessory stands, protectors, etc.

### PRIOR ART

Several types of prevention bars or barriers are used to protect patients against bed leaving or fall from the bed. Such barriers can be fixed, e.g. side rails, or removable, e.g. protectors, headboards or footboards of patient support apparatuses. Removable parts enable medical staff and caregivers to access patient and to maintain the support deck of support apparatus easier.

Several mechanisms are used to lock removable parts. These mechanisms are primarily manually controlled mechanisms, which a caregiver needs to lock consciously to avoid any undesired release of a removable part of the support apparatus. Lever mechanisms or mechanisms with spring elements are often used.

A magnetic locking element of a door of a new-born incubator is disclosed in the Japanese patent JPH09583. Movement of this locking element is limited to rotatory movement in the incubator door hinge. Function of the door is to provide tightness and to keep the inner environment unchanged, therefore magnetic element is used.

The document US2014346072 discloses a protective box for surgery, such as surgical grafts, implants, and devices, comprising magnetic guiding mechanism for easy closing of the box. Movement is restricted by rotary movement around box door hinge. However, there is a lack of any locking mechanism as pure independent movement caused by magnetic power is not sufficient.

Another embodiment of a locking device is disclosed in the document U.S. Pat. No. 7,415,912. The locking device comprises a clamp having an opening to accommodate the locking device. The clamp comprises a movable element inside which is fixed by a locking element. The locking element tightens the movable element by means of screw line which the locking element comprises, or another option is disclosed with fixed openings inside the movable element which engage the locking device. The locking device may be drawn into the locked position by means of a spring.

Another locking mechanism is disclosed in the document U.S. Pat. No. 6,058,531 where a guard rail is rotatable around horizontal axis and, in each position, at least a part of the support deck is covered with the guard rail to avoid fall of a patient from the support apparatus. Movement of this barrier is restricted by cutting out in the pad to which the guard rail is fixed. This pad is pivotably attached to the frame of the patient support apparatus. A locking element in the form of a pin engaging the opening is drawn mechanically by a spring.

Regardless the type of any locking mechanism there still a risk remains that a caregiver forgets to lock a removable part or locks such part improperly after putting back onto the patient support apparatus.

### SUMMARY OF THE INVENTION

The above stated insufficiencies of the existing known technical solutions are solved by presented technical solution for self-locking cradle mechanism to lock removable parts of patient support apparatuses. A patient support apparatus comprises an undercarriage, a lifting device of the patient support apparatus, a support deck, a frame of the support deck, guiding posts of side rails, and guiding posts of removable parts of the patient support apparatuses. Such removable parts of the patient support apparatuses can be headboards, footboards, protector barrier, or side rails.

The removable part of the patient support apparatus comprises a removable part frame and guiding posts attached to the frame of the support deck. The removable part moves within the space between these guiding posts. The frame of the removable part comprises at least one self-locking cradle latch, preferably two self-locking cradle latches, at each side of the bottom part of the removable part frame. The self-locking cradle latch can be preferably located in the corners of the removable part frame, or in one point of the removable part, or in the middle of removable part frame depending how the removable part of the patient support apparatus is designed. Should a patient support apparatus be equipped with protector or other removable accessory, the self-locking cradle latch can be located also in the structural part of such protector or other removable part. In the preferred embodiment, the removable part of the patient support apparatus comprises a removable part body attached to removable part frame. The removable part frame comprises a bottom part, an upper part, and two side parts of the removable part.

The entire removable part of a patient support apparatus is inserted into the patient support apparatus and comprises a self-locking cradle mechanism. The self-locking cradle mechanism comprises a control element with a rod to unlock or lock the cradle latch, a movable cradle latch, and a shaped stop with an alcove to accommodate the cradle latch. The control element controls movement of the rod by means of a spring element, whereas all these elements are located at the removable part frame. In preferred embodiment, the control element with spring element and the rod direct vertically to at least one end of the cradle latch in the removable part frame. The rod restricts space in which the cradle latch moves in swinging motion.

The cradle latch moves free on its anchoring point, which is in the middle of the cradle latch. The cradle latch is fixed in the anchoring point by a pin, or is put on the fixing point in the removable part frame, or optionally the cradle latch may be located in a casing of the removable part depending on structure and design of the removable part of the patient support apparatus. In the preferred embodiment, the removable part body is made of glass or any transparent material, e.g. plexiglass or other plastic material. The removable part body in inserted in the metal or aluminium frame, however optionally, this frame can be made of other convenient material such as plastics, wood, metal alloy or plastic alloy. In the preferred embodiment, the cradle latch is located at the bottom corners of the removable part frame where space for the cradle latch is restricted by the rod, which is coupled via spring with the control element by which the restricted space for movement of the cradle latch is unlocked in case the removable part needs to be taken out from the frame thus causing movement of the cradle latch.

The cradle latch moves whereas volume of movement is restricted by size of the frame, i.e. thickness of the removable part frame. The cradle latch is preferably of rounded shape which tapers toward the ends of the latch so that the cradle latch could rock or swing upward and downward.

The cradle latch is attached in its middle point to the anchoring point or is fixed by means of a pin. Swinging or rocking movement of the cradle latch upward and downward enables to lock the removable part of the patient support apparatus in the desired position (so called locked position), but also enables to unlock the removable part of the patient support apparatus to move the removable part off the patient support apparatus. The cradle latch engages the alcove of the shaped spot and protects the removable part to be taken out of the frame of the patient support apparatus. In the second position, the cradle latch is released from the alcove of the shaped stop by pushing the control element causing change of the rod position. In this second position the removable part can move any may be taken out of the frame of the patient support apparatus.

The self-locking cradle mechanism for locking and unlocking of removable parts of patient support apparatuses increases comfort of caregivers when handling such removable parts. The self-locking cradle mechanism is easily structured and nearly maintenance-free, either with respect to maintenance of mechanical components or to cleaning and disinfection. In addition, safety of patients is higher.

In the preferred embodiment the cradle latch is located at the removable part frame and the shaped stop is located at the guiding post.

In another embodiment, the cradle latch is located at the casing of the patient support deck frame.

### LIST OF DRAWINGS

FIG. 1 shows a removable part of a patient support apparatus comprising self-locking cradle mechanism, guiding posts, and a support deck frame part.

FIG. 2 shows a part of a removable part of a patient support apparatus comprising a control element to control a rod, and a part of a bottom part of the frame comprising a cradle latch.

FIG. 3 shows a part of a removable part frame comprising a cradle latch in free position, and a part of a patient support deck frame.

FIG. 4 shows an unlocked position of a cradle latch, and a part of a removable part.

FIG. 5 shows position of a cradle latch moving from unlocked position to locked position.

FIG. 6 shows position of a cradle latch in the locked position.

FIG. 7 shows unlocking of a cradle latch before taken a removable part out of a patient support apparatus.

FIG. 8 shows unlocked position of a cradle latch upon taking a removable part out of a patient support apparatus.

### LIST OF REFERENCES

1) Removable part
2) Removable part body
3) Removable part frame
   3a) bottom part of the frame
   3b) upper part of the frame
   3c) side part of the frame
4) Cradle latch
5) Control element
6) Spring element (spring)
7) Rod
8) Patient support deck frame
9) Guiding posts of patient support apparatus
10) Shaped stop
11) Anchoring point

### Exemplary Embodiments of the Invention

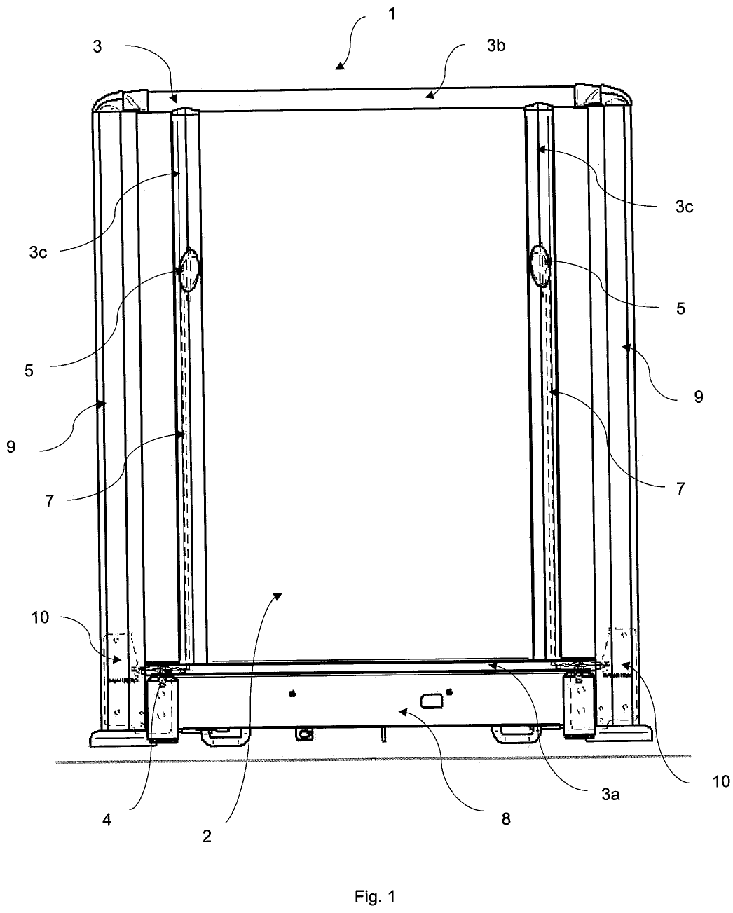

The presented technical solution discloses a self-locking cradle mechanism for locking of removable parts 1 of patient support apparatuses. The removable parts 1 can be for example headboards, footboards, protectors, iv poles or accessory poles attachable to patient support apparatuses. FIG. 1 shows a removable part 1 of a patient support apparatus comprising a body 2 of the removable part and a frame 3 of the removable part. The body 2 of the removable part is preferably made of transparent material such as transparent plastic board or glass, optionally the body 2 of the removable part can be made of non-transparent material such as plastic boards, plywood boards or board made of other convenient and resistant material. The body 2 of the removable part is free embedded in the frame 3 of the removable part. The frame 3 of the removable part comprises a bottom part of the frame 3a, an upper part of the frame 3b and two side parts of the frame 3c. In the preferred embodiment, the body 2 of the removable part is free embedded in the frame 3 of the removable part as one unit having four sides.

Preferably, a self-locking cradle latch 4 is located at the bottom part of the frame 3a of the removable part 1, which is attached in its middle point to the anchoring point 11 (not shown in this figure). The cradle latch 4 preferably moves swinging toward a shaped stop 10. The shaped stop 10 is located at the bottom part of the guiding posts 9 of the patient support apparatus. The shaped stop 10 impacts swinging and rocking movement of the cradle latch 4 and the position of the cradle latch 4 in the bottom part of the frame 3a.

A control element 5 is located at the side part of the frame 3c of the removable part 1 preferably in the upper half of the side part of the frame 3c on the external side. This control element 5 is coupled, by means of a spring element 6 (not shown herein), with a rod 7, which directs vertically down and goes through down to the bottom part of the frame 3a, which is horizontal in relation to the side part of the frame 3c. The control element 5 has preferably ergonomic shape for easy handling by a thumb. The rod 7 is controlled by the control element 5 and affects movement of the cradle latch 4, which preferably located at the bottom part of frame 3a.

The removable part 1 comprises at least one protruding point on the bottom edge of the upper part of the frame 3b for fixing the removable part 1, which engages to the openings in the guiding posts 9 of the patient support apparatus located coupled to the patient support deck frame 8.

At least one cradle latch 4 is located at the bottom part 3a of the removable part frame 3, preferably there are two cradle latches 4 located at the bottom part of the frame 3a, wherein at least one end of the cradle latch 4 protrudes partially out of the bottom part of the frame 3a. The protruding part of the cradle latch 4 engages a shaped stop 10, which is located at the bottom part of the guiding post 9 of the patient support apparatus. In the preferred embodiment, the removable part 1 of the patient support apparatus comprises two cradle latches 4 to lock the removable part 1 between the guiding posts 9 of the patient support apparatus, which are attached to the patient support deck frame 8. Both guiding posts 9 of the patient support apparatus comprise a shaped stop 10 at their bottom part.

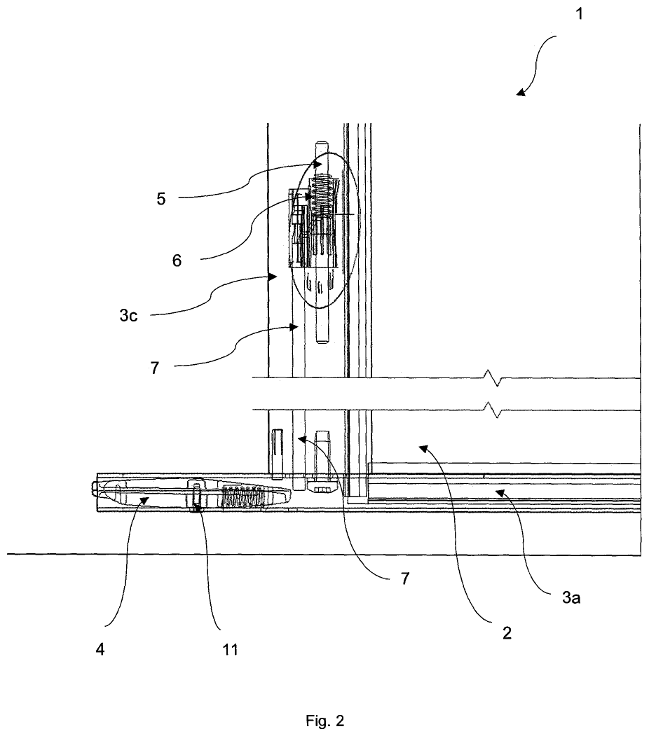

The FIG. 2 shows an upper part of a removable part 1 comprising a control element 5 and a bottom part of a frame 3a comprising a cradle latch 4 to lock or unlock the removable part 1 of a patient support apparatus. The control element 5 is coupled, by means of a spring element 6 with a rod T The spring element 6 pushes the rod 7 automatically downwards. The control element 5 is preferably located at the external side of the removable part frame 3, vertically in relation to the patient support deck frame 8. The spring element 6 is located together with the rod 7 at the side part of the frame 3c of the removable part 1. The rod 7 goes through down to the bottom part of the frame 3a.

A cradle latch 4 is located at, at least, one end of a bottom part of the frame 3a. The cradle latch 4 is preferably of rounded shape which tapers toward the ends of the latch so that the cradle latch 4 could rock or swing upward and downward. In the preferred embodiment, the cradle latch 4 may comprise a spring element 6, which is located at, at least, one end of the cradle latch 4 and fixed so that the cradle latch 4 could automatically engage a shaped stop 10 in the guiding post 9 of the patient support apparatus. The spring element 6 can be a metal spring or a rubber elastic element. The cradle latch 4 can be of rectangular, oblique, cylindrical or square shape with rounded bottom part. The cradle latch 4 is free attached in its middle point to the anchoring point 11 to move swinging or rocking. The anchoring point 11 can be a pin or screw by which the cradle latch 4 is fixed to the bottom part of the frame 3a. The FIG. 2 shows the cradle latch 4 in free position.

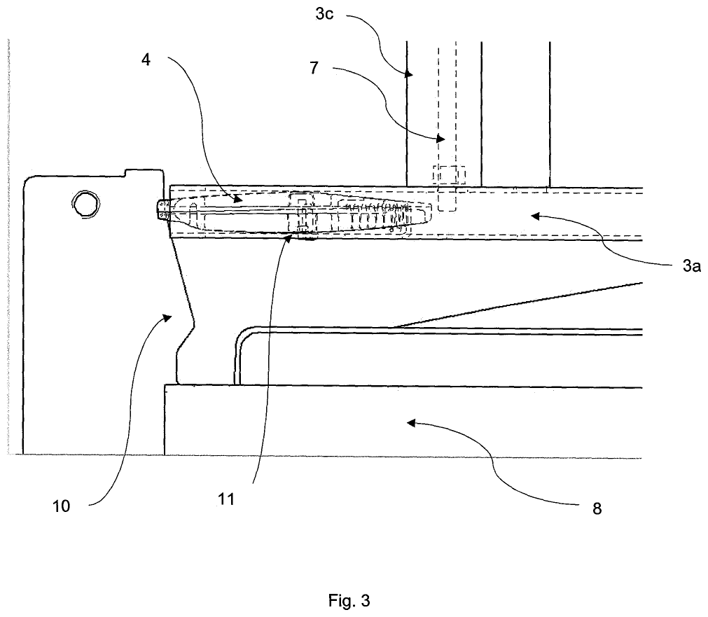

The FIG. 3 shows a part of a patient support deck frame 8 comprising a shaped stop 10 attached to the patient support deck frame 8 in a point where a guiding post 9 of the patient support apparatus (not shown herein) is fixed. In addition, the FIG. 3 shows a free positioned cradle latch 4 located at the bottom part of the frame 3a and attached to an anchoring point 11, by which swinging movement of the cradle latch 4 is caused. The FIG. 3 also shows a rod 7 that avoids the cradle latch 4 to move into the locked position. In this embodiment, the removable part 1 is outside the patient support deck frame 8 and guiding posts 9 of the patient support apparatus (not shown herein). The part of the rod 7 goes through the side part of the frame 3c of removable part into the bottom part of the frame 3a of removable part thus protecting the cradle latch to slide under the rod 7.

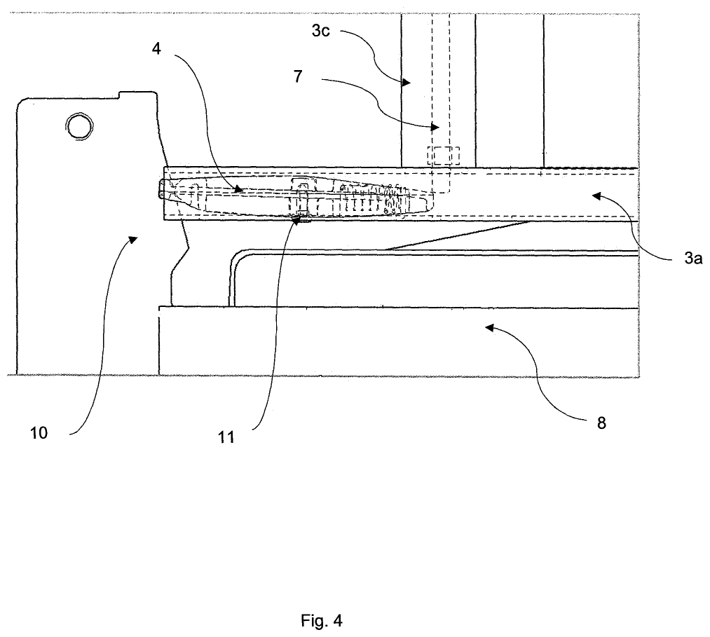

The FIG. 4 shows unlocked position of a cradle latch 4 before locking. At least one end of the cradle latch 4 protrudes out of the bottom part of the frame 3a and is in contact with a shaped stop 10 of the guiding posts 9 of the patient support apparatus. At the moment of inserting the removable part 1 the position of the cradle latch 4 changes. The FIG. 4 shows tilting of the cradle latch 4 such that the external end of the cradle latch 4 is in the upper position and the opposite end of the cradle latch 4, which is inside the bottom part of the frame 3a, is in lower position, whereas directs under the rod 7 of the control element 5.

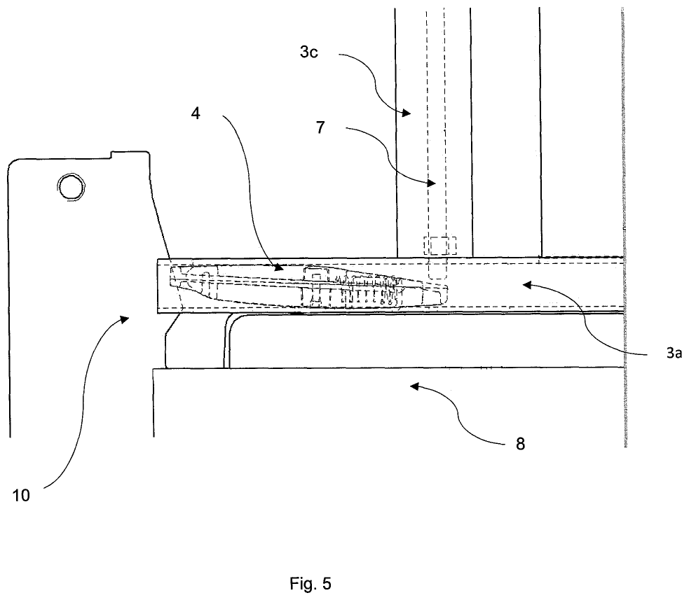

The FIG. 5 shows a position of a cradle latch 4 where the external end of the cradle latch 4 overcomes the locking point of a shaped stop 10 as the cradle latch 4 is lifted to its maximum and the opposite end of the cradle latch 4 tilts and the cradle latch 4 flips under the rod 7. After overcoming this point of the shaped stop 10 the cradle latch 4 flips back and drops into the locked position.

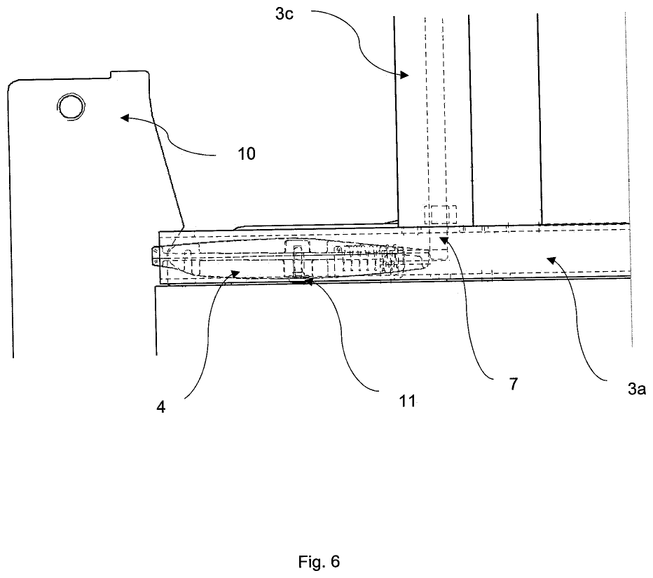

The locked position of the cradle latch 4 is shown in the FIG. 6 where the cradle latch 4 returns back to the horizontal position and the external end of the cradle latch 4 gets under the shaped stop 10. At the opposite end of the cradle latch 4 a rod 7 of a control element 5 protects the cradle latch 4 to move into the tilted position under the rod 7. This position tight lock the removable part 1 of the patient support apparatus in between the guiding posts 9 of the patient support apparatus and the patient support deck frame 8 such that the removable part 1 protects patient to exit of fall from the patient support apparatus. The removable part 1 cannot be raised out now.

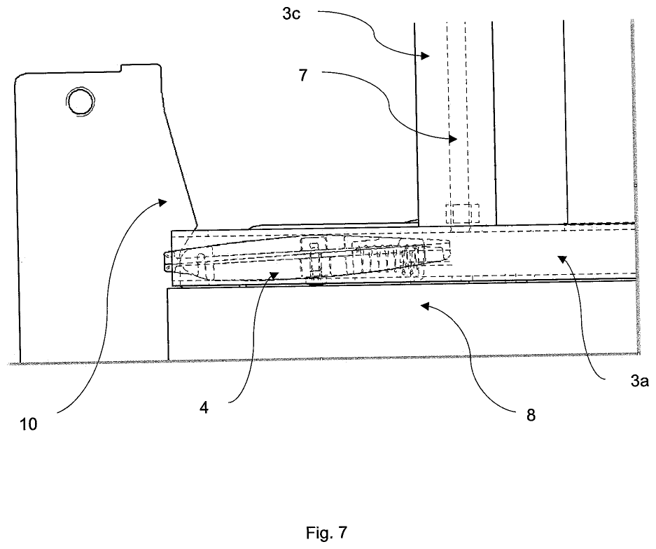

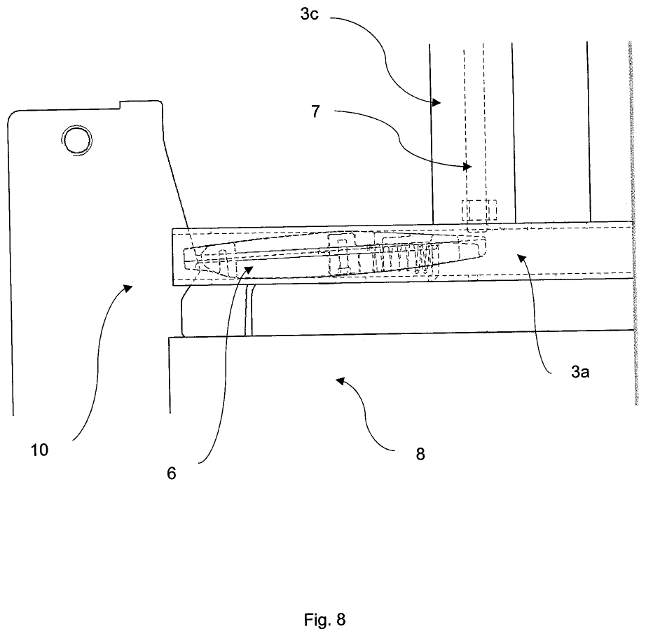

The FIG. 7 shows unlocking of a cradle latch 4 and change of position of a rod 7 where the rod 7 is raised up by means of a control element 5 from its locked position. The inner end of the cradle latch 4 tilts upwards to the inner side of the bottom part of the frame 3a. Consequently, upon raising the removable part 1 out of the patient support apparatus, the cradle latch 4 gets in contact with the protrusion of a shaped stop 10 that thus automatically pushes the cradle latch 4 into the opposite direction where the external end of the cradle latch 4 directs downwards and the opposite end of the cradle latch 4 upwards under the rod 7 by which the cradle latch 4 is self-unlocked. This position is also shown in the FIG. 8, where the cradle latch 4 is in unlocked position.

As stated above, the FIG. 8 shows the unlocked position of the cradle latch 4. The protrusion of a shaped stop 10 obviously positioned the cradle latch 4 into the unlocked position and the opposite end of the cradle latch 4 is raised under the rod 7. The FIG. 8 shows raising the removable part 1 out of the patient support apparatus. The bottom part of the frame 3a of the removable part 1 is no longer on the patient support deck frame 8 but is located now above the patient support deck frame 8. All figures obviously show that self-locking and self-unlocking of the cradle latch 4 occurs automatically according to in which direction the removable part 1 of the patient support apparatus moves. The control element 5 is used only due to safety reasons for releasing of positioning of the cradle latch 4 to lock or unlock the space for movement of the cradle latch 4.

1. A patient support apparatus with self-locking mechanism comprising an undercarriage with casters, a lifting device, a support deck, and a patient support deck frame, wherein the patient support deck frame comprises side rails, guiding posts with a shaped stop, and at least one removable part, wherein the removable part comprises a removable part body and a removable part frame comprising three parts including a bottom part of the frame, an upper part of the frame and a side part of the frame, wherein the removable part frame comprises a control element, a rod and a cradle latch located between the shaped stop and the rod, which both restrict space for the cradle latch.

2. The patient support apparatus with self-locking mechanism according to claim 1, wherein the rod is coupled with the control element located in the side part of the frame of the removable part of the patient support apparatus.

3. The patient support apparatus with self-locking mechanism according to claim 2, wherein the control element and the rod are located in the side part of the frame of the removable part of the patient support apparatus vertically in relation to the cradle latch.

4. The patient support apparatus with self-locking mechanism according to claim 1, wherein the cradle latch is located horizontally in the bottom part of the frame of the removable part of the patient support apparatus.

5. The patient support apparatus with self-locking mechanism according to claim 1, wherein the cradle latch protrudes out of the bottom part of the frame of the removable part of the patient support apparatus to be in contact with the shaped stop.

6. The patient support apparatus with self-locking mechanism according to claim 5, wherein the shaped stop is a part of the guiding post of the patient support apparatus outside the removable part frame.

7. The patient support apparatus with self-locking mechanism according to claim 1, wherein the cradle latch is attached in its middle point to an anchoring point, which is located at the middle of the bottom side of the cradle latch.

8. The patient support apparatus with self-locking mechanism according to claim 1, wherein the cradle latch is of rectangular shape wherein a bottom side of the cradle latch is bowed or curved to create a cradle shape.
